(19) United States
(12) Patent Application Publication
(10) Pub. No.: US 2003/0006872 A1
(43) Pub. Date: Jan. 9, 2003

(54) Coil spool for ventilated solenoid valve

(76) Inventors: Amiyo K. Basu, El Paso, TX (US); David W. Lehrschall, El Paso, TX (US)

Correspondence Address: MARGARET A. DOBROWITSKY, DELPHI TECHNOLOGIES, INC., P.O. Box 5052, Mail Code: 480-414-420, Troy, MI, 48007-5052, US

(21) Appl. No.: 09/900,786

(22) Filed: Jul. 6, 2001

(51) Int. Cl. H01F 27/02

(52) U.S. Cl. 336/90

(57) ABSTRACT

A coil spool for a ventilated solenoid valve includes a proximal end cap and a distal end cap. Each end cap defines an outer periphery and an inner periphery. Moreover, each end cap includes plural teeth extending from its outer periphery. Plural ribs extend from the inner periphery of the proximal end cap to the inner periphery of the distal end cap. A wire is wound around the spool to form a coil and the spool is installed in a coil case such that the teeth cooperate with the coil case to establish plural outer ventilation passageways. A plunger guide is installed within the spool such that the ribs cooperate with the plunger guide to establish plural inner ventilation passageways. The ventilation passageways allow air to communicate with the coil in order to cool the coil.

### TECHNICAL FIELD

The present invention relates to solenoids and actuators.

### BACKGROUND OF THE INVENTION

To comply with state and federal environmental regulations, most motor vehicles are now equipped with a carbon canister installed to trap and store petroleum fuel vapors from the carburetor bowl and/or the fuel tank. With the canister, fuel vapor is not vented to the atmosphere, but instead is trapped in the canister and then periodically purged from the canister into the engine where the fuel vapor is burned along with the air-fuel mixture.

Solenoid valves and actuators have been provided that are used to purge the fuel vapor from the carbon canister. A typical purge valve includes a coil disposed around a plunger. When the coil is energized to create a magnetic field around the plunger, the magnetic field biases the plunger either from an open position to a closed position or from a closed position to an open position. Thus, a normally open valve closes when the coil is energized and a normally closed valve opens when the coil is energized. In either case, when the coil is energized it generates heat. Unfortunately, as recognized herein, the heat generated by the coil can be detrimental to the operation of the solenoid valve. For example, as the heat increases, the thermodynamic efficiency of the coil decreases. Moreover, as the heat increases, the power consumption of the solenoid valve also increases.

The present invention has recognized these prior art drawbacks, and has provided the below-disclosed solutions to one or more of the prior art deficiencies.

### SUMMARY OF THE INVENTION

A ventilated solenoid valve includes a coil case that has a spool disposed therein. The spool cooperates with the coil case to establish plural outer ventilation passageways. A plunger guide is disposed within the spool such that the plunger guide cooperates with the spool to establish plural inner ventilation passageways.

Preferably, the spool includes a proximal end cap and a distal end cap. Each end cap defines an outer periphery that has plural teeth extending therefrom. The teeth cooperate with the coil case to establish the outer ventilation passageways. In a preferred embodiment, the teeth and the outer ventilation passageways are equally spaced around the outer periphery of the end caps. Preferably, each end cap defines an inner periphery and the spool includes plural ribs that extend from the inner periphery of the proximal end cap to the inner periphery of the distal end cap. The ribs cooperate with the plunger guide to establish the plural inner ventilation passageways.

In a preferred embodiment, the ribs and the inner ventilation passageways are equally spaced around the inner periphery of the end caps. Moreover, the spool defines a winding area and the valve further includes a wire wound around the spool within the winding area to form a coil. As intended by the present invention, the passageways allow air to communicate with the coil.

In another aspect of the present invention, a spool is used in conjunction with a solenoid valve that has a coil case and a plunger guide. The spool is installed within the coil case and includes a proximal end cap and a distal end cap. Each end cap defines an outer periphery and an inner periphery. Plural teeth extend from the outer periphery of each end cap. Moreover, plural outer ventilation passageways are established between the teeth and the coil case. Also, in this aspect of the present invention, plural ribs extend from the inner periphery of the proximal end cap to the inner periphery of the distal end cap. Plural inner ventilation passageways are established between the ribs and the plunger guide.

In yet another aspect of the present invention, a solenoid valve includes a coil case and a spool disposed therein. In this aspect of the present invention, the spool forms plural outer ventilation passageways and plural inner ventilation passageways. Moreover, a wire is wound around the spool to form a coil. The ventilation passageways allow air to communicate with the coil to dissipate heat generated thereby.

In still another aspect of the present invention a spool is used in conjunction with a solenoid valve that has a coil case and a plunger guide. The spool is installed within the coil case. In this aspect of the present invention, the spool includes means for establishing plural outer ventilation passageways between the spool and the coil case. Additionally, the spool includes means for establishing plural inner ventilation passageways between the spool and the plunger guide.

The present invention will now be described, by way of example, with reference to the accompanying drawings, in which:

### BRIEF DESCRIPTION OF THE DRAWINGS

FIG. 1 is a perspective view of a spool;

FIG. 2 is an end plan view of the spool; and

FIG. 3 is an end plan view of a coil assembly with the spool disposed therein.

### DESCRIPTION OF AN EMBODIMENT OF THE INVENTION

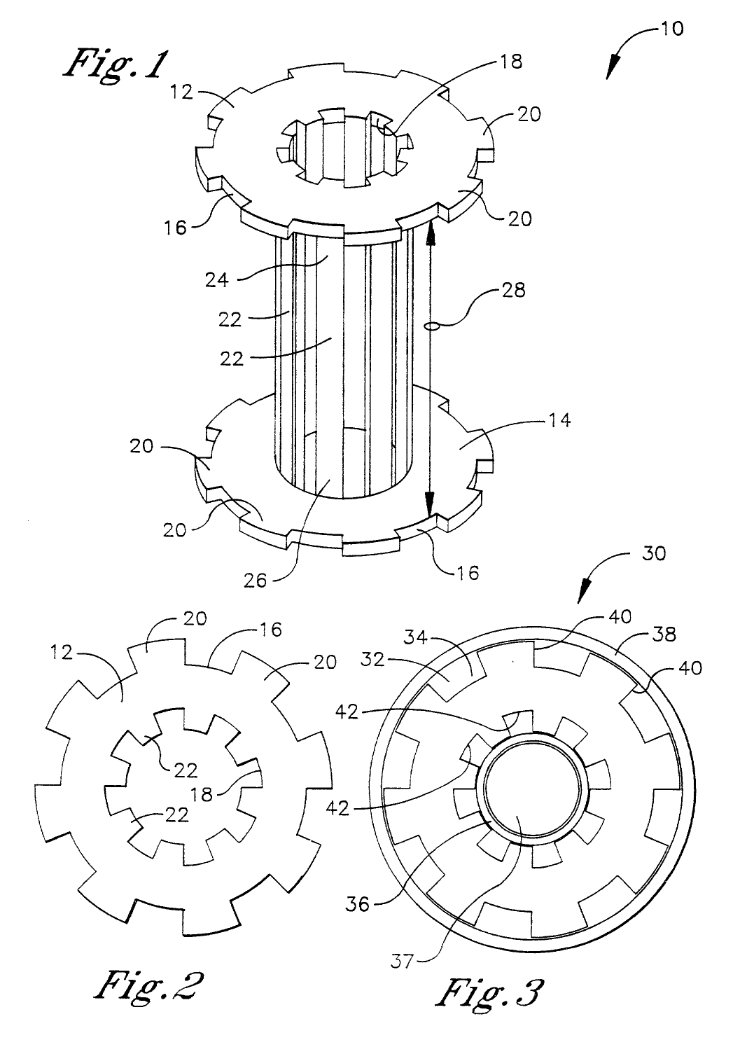

Referring initially to FIG. 1, a generally “I” shaped spool is shown and generally designated 10. FIG. 1 shows that the spool 10 includes a hollow, generally disc-shaped, proximal end cap 12 and a hollow, generally disc-shaped distal end cap 14. The end caps 12, 14 are identical to each other and each defines an outer periphery 16 and an inner periphery 18. Moreover, each end cap 12, 14 forms plural teeth 20 which extend radially from the outer periphery 16.

As shown in FIG. 1, the spool 10 includes plural ribs 22 installed perpendicularly between the proximal end cap 12 and the distal end cap 14. Each rib 22 defines a proximal end 24 and a distal end 26. The proximal ends 24 of the ribs 22 are attached to the inner periphery 18 of the proximal end cap 12. On the other hand, the distal ends 26 of the ribs 22 are attached to the inner periphery 16 of the distal end cap 14. In one embodiment, the ribs 22 are integrally formed with the end caps 12, 14 as a single piece, e.g, by an injection molding process. It is to be appreciated, however, that the end caps 12, 14 and the ribs 22 may be formed separately and then attached to each other to form the spool 10. In any case, the ribs 22 extend radially inward from the inner periphery 18 of each end cap 12, 14. FIG. 1 shows a winding area 28 formed around ribs 22 between the proximal end cap 12 and the distal end cap 14. As described below, a wire may be wound around the spool 10 in the winding area 28 to form a coil.

FIG. 2 shows the proximal end cap 12. As shown in FIG. 2, in a preferred embodiment, the teeth 20 are equally spaced around the outer periphery 16 of the proximal end cap 12. Moreover, in a preferred embodiment, the ribs 22 are equally spaced around the inner periphery 18 of the proximal end cap 12. It can be appreciated, however, that the teeth 20 and ribs 22 need not be equally spaced around the end cap 12.

Referring now to FIG. 3, a ventilated solenoid valve is shown and generally designated 30. FIG. 3 shows that the valve 30 includes the spool 10, described above, around which a wire 32 is wound to form a coil 34. As shown in FIG. 3, a hollow, generally cylindrical plunger guide 36 is disposed within the spool 10, A magnetically actuated plunger 37 is installed within the plunger guide 36. Additionally, a generally cylindrical, hollow coil case 38 surrounds the spool 10. FIG. 3 shows that when the spool 10 is installed in the coil case 38, the teeth 20 formed by the end caps 12, 14 cooperate with the interior of the coil case 38 to form plural outer ventilation passageways 40 around the outer periphery 16 of each end cap 12, 14. Also, the plunger guide 36 cooperates with the ribs 22 to form plural inner ventilation passageways 42. Thus, as intended by the present invention, air can flow axially through the valve 30 to cool the coil 34.

With the configuration of structure described above, it is to be appreciated the inner and outer ventilation passageways 40, 42 formed between the spool 10 and the plunger guide 36 and the spool 10 and the coil case 38 allow air to flow through the coil assembly 30 in order to cool the coil 34 during operation. Thus, the efficiency of the coil 34 is promoted. Moreover, the structure of the spool 10, e.g., the space between the teeth 20 and the space between the ribs 26, conserves manufacturing materials while providing for a good flow rate of exhaust products.

While the particular COIL SPOOL FOR VENTILATED SOLENOID VALVE as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

1. A ventilated solenoid valve, comprising:
a coil case;
a spool disposed within the coil case such that the spool cooperates with the coil case to establish plural outer ventilation passageways; and
a plunger guide disposed within the spool such that the plunger guide cooperates with the spool to establish plural inner ventilation passageways.

2. The solenoid valve of claim 1, wherein the ventilate spool includes a proximal end cap and a distal end cap, each end cap defines an outer periphery having plural teeth extending therefrom, the teeth cooperating with the coil case to establish the outer ventilation passageways.

3. The solenoid valve of claim 2, wherein the teeth and the outer ventilation passageways are equally spaced around the outer periphery of the end caps.

4. The solenoid valve of claim 2, wherein each end cap defines an inner periphery and the spool includes plural ribs extending from the inner periphery of the proximal end cap to the inner periphery of the distal end cap, the ribs cooperating with the plunger guide to establish the plural inner ventilation passageways.

5. The solenoid valve of claim 4, wherein the ribs and the inner ventilation passageways are equally spaced around the inner periphery of the end caps.

6. The solenoid valve of claim 1, wherein the spool defines a winding area and the valve further comprises:
a wire wound around the spool within the winding area to form a coil, the passageways allowing air to communicate with the coil.

7. A spool for use in conjunction with a solenoid valve having a coil case and a plunger guide, the spool being installed within the coil case, the spool comprising:
a proximal end cap;
a distal end cap, each end cap defining an outer periphery and an inner periphery;
plural teeth extending from the outer periphery of each end cap;
plural outer ventilation passageways being established between the teeth and the coil case;
plural ribs extending from the inner periphery of the proximal end cap to the inner periphery of the distal end cap; and
plural inner ventilation passageways being established between the ribs and the plunger guide.

8. The spool of claim 7, wherein the teeth and the outer ventilation passageways are equally spaced around the outer periphery of the end caps.

9. The spool of claim 7, wherein the ribs and the inner ventilation passageways are equally spaced around the inner periphery of the end caps.

10. The spool of claim 7, further comprising:
a winding area established around the ribs between the proximal end cap and the distal end cap; and
a wire wound around the spool within the winding area to form a coil, the passageways allowing air to communicate with the coil.

11. A solenoid valve, comprising:
a coil case;
a spool disposed within the coil case, the spool forming at least portions of plural outer ventilation passageways and plural inner ventilation passageways; and
a wire wound around the spool to form a coil, the ventilation passageways allowing air to communicate with the coil.

12. The solenoid valve of claim 11 further comprising a plunger guide disposed within the spool and the ventilation spool comprises:
a proximal end cap;
a distal end cap, each end cap defining an outer periphery and an inner periphery;
plural teeth extending from the outer periphery of each end cap, the teeth cooperating with the coil case to establish the outer ventilation passageways; and
plural ribs extending from the inner periphery of the proximal end cap to the inner periphery of the distal end cap, the ribs cooperating the plunger guide to establish the plural inner ventilation passageways.

13. The valve of claim 12, wherein the teeth and the outer ventilation passageways are equally spaced around the outer periphery of the end caps.

14. The valve of claim 12, wherein the ribs and the inner ventilation passageways are equally spaced around the inner periphery of the end caps.

15. A spool for use in conjunction with a solenoid valve having a coil case and a plunger guide, the spool being installed within the coil case, the spool comprising:
means for establishing plural outer ventilation passageways between the spool and the coil case; and
means for establishing plural inner ventilation passageways between the spool and the plunger guide.

16. The spool of claim 15, further comprising:
coil means disposed around the spool.
